(19) United States
(12) Patent Application Publication
(10) Pub. No.: US 2026/0219463 A1
(43) Pub. Date: Jul. 30, 2026

(54) OPTICAL TRANSMISSION ASSEMBLY AND OPTICAL MODULE

(71) Applicant: Prime World International Holdings Ltd., New Taipei City (TW)

(72) Inventors: Yu CHEN, New Taipei City (TW); Che-Shou YEH, New Taipei City (TW); Ling-An KUNG, New Taipei City (TW); Ming-You LAI, New Taipei City (TW); Hsuan-Chen SHIU, New Taipei City (TW); Yi-Ju WANG, New Taipei City (TW)

(21) Appl. No.: 19/236,726

(22) Filed: Jun. 12, 2025

(30) Foreign Application Priority Data
Jan. 24, 2025 (TW) 114103324

(51) Int. Cl. G02B 6/42

(52) U.S. Cl. CPC G02B 6/4278; G02B 6/426; G02B 6/428

(57) ABSTRACT

The present disclosure provides an optical transmission assembly and an optical module. The optical module includes a housing, a baseplate, an active optical component, an optical fiber connector, an optical fiber, and a sealing component. The baseplate is located in the housing. The active optical component is coupled to the baseplate. The optical fiber connector is coupled to the housing. The optical fiber includes a first end portion and a second end portion. The first end portion is optically coupled to the active optical component. The second end portion is coupled to the optical fiber connector. The sealing component is located in the housing. The second end portion of the optical fiber is sealed in the sealing component.

### CROSS-REFERENCE TO RELATED APPLICATIONS

This non-provisional application claims priority under 35 U.S.C. § 119(a) on Patent Application No(s). 114103324 filed in Republic of China on January 24^{th}, 2025, the entire contents of which are hereby incorporated by reference.

### BACKGROUND

### Technical Field

This disclosure relates to an optical module and optical transmission assembly.

### Related Art

An optical module may transmit and/or receive an optical signal for applications such as, but not limited to, a data center, a cable television (Cable TV) and a fiber to the home (FTTH). Using an optical module to transmit may provide higher transmission rate and signal bandwidth under longer transmission distance. To facilitate the compatibility of global optical internet products and reduce maintenance burden, organizations such as Multi-Source Agreement (MSA), Institute of Electrical and Electronics Engineers (IEEE) and Optical Internetworking Forum (OIF) develop a plurality of form factors suitable for different signal transmission rates. These form factors include but not limited to XFP, SFP, Quad Small Form Factor Pluggable (QSFP), QSFP-Double Density (DD), Octal Small Form Factor Pluggable (OSFP) and Co-Packaged Optics (CPO).

Existing optical modules face challenges such as optical power, space management, thermal management, insertion loss and manufacturing yield.

### SUMMARY

According to an embodiment of this disclosure, an optical module includes a housing, a baseplate, an active optical component, an optical fiber connector, an optical fiber and a sealing component. The baseplate is located in the housing. The active optical component is coupled to the baseplate. The optical fiber connector is coupled to the housing. The optical fiber includes a first end portion and a second end portion. The first end portion is optically coupled to the active optical component. The second end portion is coupled to the optical fiber connector. The sealing component is located in the housing. The second end portion of the optical fiber is sealed in the sealing component.

According to another embodiment of this disclosure, an optical transmission assembly includes a baseplate, an active optical component, an optical fiber connector and an optical fiber. The active optical component is coupled to the baseplate. The optical fiber includes a first end portion and a second end portion. The first end portion is optically coupled to the active optical component. The second end portion is coupled to the optical fiber connector. The sealing component is coupled to the optical fiber connector. The second end portion of the optical fiber is sealed in the sealing component.

According to yet another embodiment of this disclosure, the optical module includes a housing, a baseplate, an active optical component, an optical fiber connector, an optical fiber and a sealing component. The baseplate is located in the housing. The active optical component is coupled to the baseplate. The optical fiber connector is coupled to the housing. The optical fiber is optically coupled to the active optical component. The optical fiber is coupled to the optical fiber connector via an adhesive. The sealing component is located in the housing. An entirety of the optical fiber is sealed in the sealing component.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a perspective view of an optical module according to an embodiment of the present disclosure;

FIG. 2 is an exploded view of the optical module of FIG. 1;

FIG. 3 is a partially enlarged view of an optical transmission assembly of FIG. 2;

FIG. 4 is an enlarged view showing a second end portion of an optical fiber in FIG. 3 coupled to a boot via an adhesive;

FIG. 5 is a perspective view of an optical module according to another embodiment of the present disclosure;

FIG. 6 is an exploded view of the optical module of FIG. 5;

FIG. 7 is a partially enlarged view of an optical transmission assembly of FIG. 6;

FIG. 8 is a perspective view of an optical module according to yet another embodiment of the present disclosure;

FIG. 9 is an exploded view of the optical module of FIG. 8;

FIG. 10 is a partially enlarged exploded view of an optical transmission assembly of FIG. 9; and

FIG. 11 is a schematic view showing the assembly of a multi-fiber push on (MPO) connector with a sealing component of FIG. 10.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

Thermal management of an optical module primarily involves transferring heat generated by a component to a housing for dissipation. With increasing demand for high-speed optical communication, power consumption of an optical module is also rising, thereby necessitating higher heat dissipation efficiency. Immersing the optical module in a coolant such as water is one of the advanced solutions for heat dissipation. However, when the optical module is immersed in the coolant, the coolant may influence the optical path, thereby affecting optical transmission efficiency.

Additionally, if the coolant contacts a passive optical component, the optical signal transmission quality of the optical module may be affected. In particular, the coolant may damage an adhesive used to secure a passive optical component to other components, and such damage may refer to chemical corrosion or the change of adhesive properties.

According to an embodiment of the present disclosure, when immersing the optical module, with a sealing component of the present disclosure, is immersed in the coolant, the optical path can be protected from damage caused by the coolant. Further, the sealing component can prevent the coolant from contacting the passive optical component and adhesive within the optical module. Moreover, by disposing a sealing reinforcement member in the sealing component, the optical fiber connector may retain a degree of freedom for movement, letting the optical fiber connector be able to effectively couple with an external connector. Furthermore, the sealing component of the present disclosure may be applied to the optical module with various connectors.

A person skilled in the art may reasonably combine the following disclosed technical features to achieve the corresponding technical effects.

The term “coupled” or “coupling” refers to any connection, linkage, or similar relationship. The term “optically coupled” or “optical coupling” refers to a relationship in which light is light imparted from one component to another component. Unless otherwise specified, components that are coupled to or coupling with each other do not need to be directly connected to each other, and may be spaced apart via one or more intermediate components.

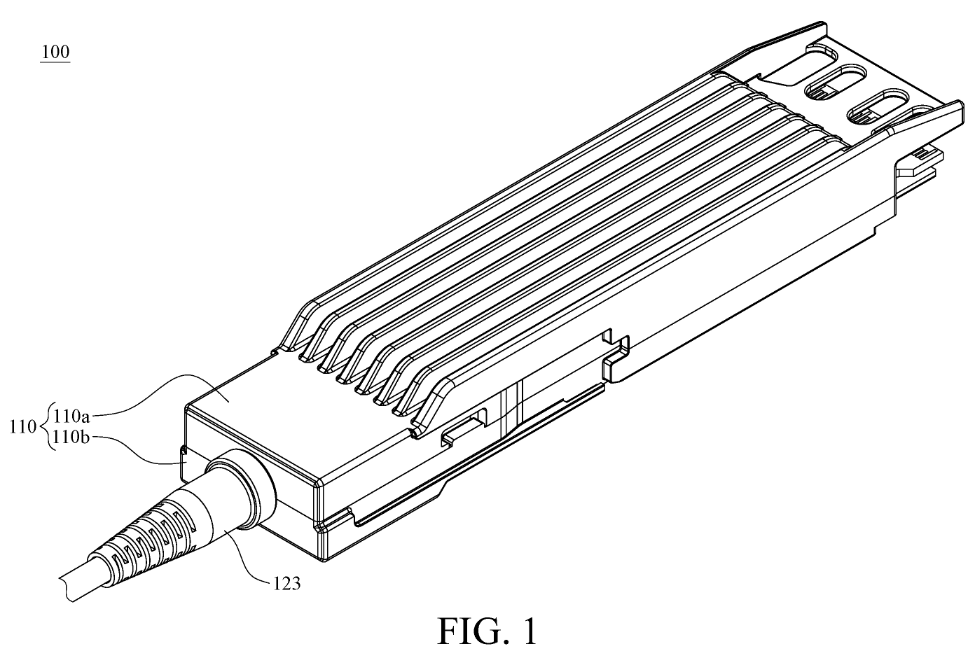

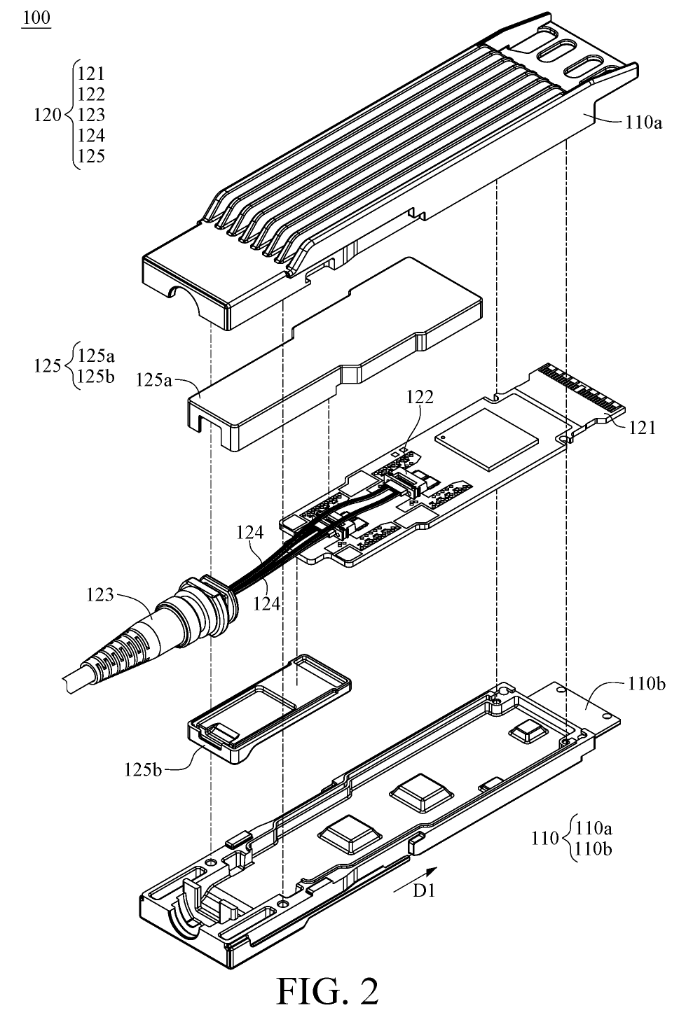

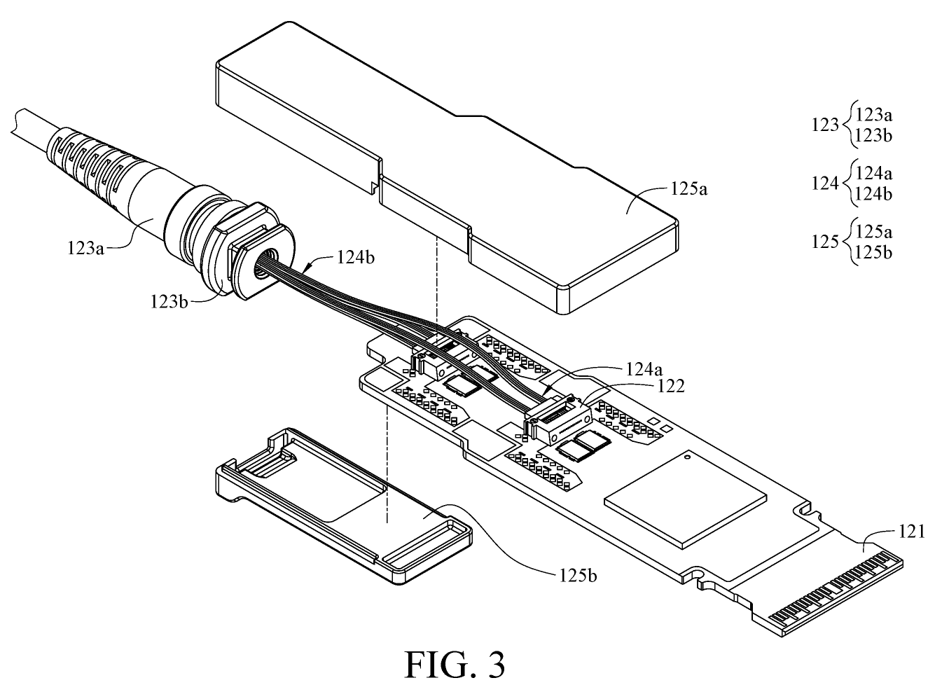

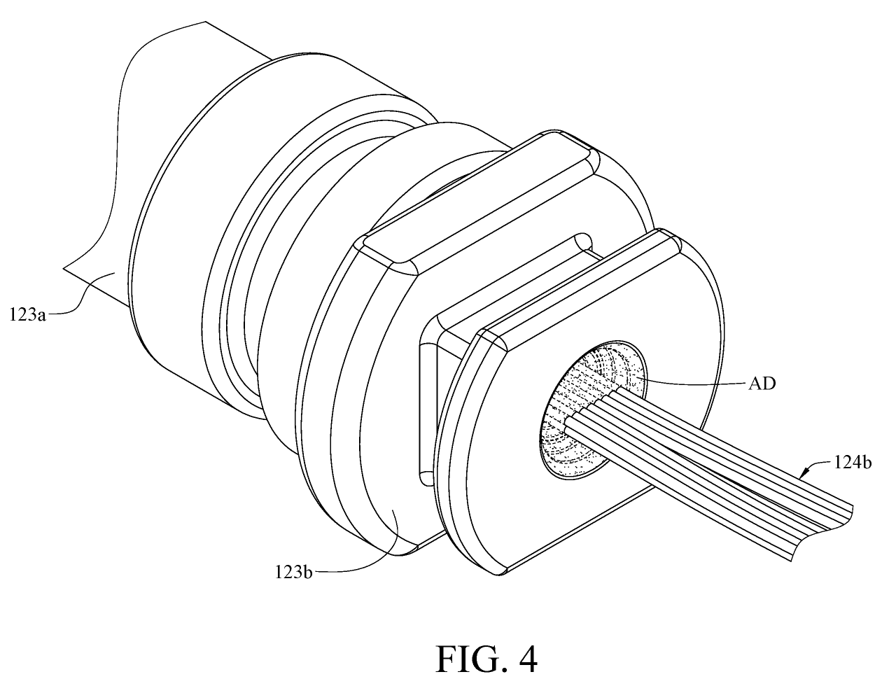

FIG. 1 is a perspective view of an optical module 100 according to an embodiment of the present disclosure. FIG. 2 is an exploded view of the optical module 100 of FIG. 1. FIG. 3 is a partially enlarged view of an optical transmission assembly 120 of FIG. 2. FIG. 4 is an enlarged view showing a second end portion of an optical fiber in FIG. 3 coupled to a boot via an adhesive. According to an embodiment, the optical module 100 may include a housing 110 and the optical transmission assembly 120.

In an embodiment, the housing 110 may be a hermetically sealed housing or non-hermetically sealed housing. In an embodiment, the housing 110 may be a unitary housing, and the optical transmission assembly 120 may be accommodated in the housing 110. In an embodiment, the housing 110 has a non-hermetic chamber for containing the optical transmission assembly 120. In an embodiment, referring to FIGS. 1 and 2, the housing 110 may be a multi-part housing comprising an upper housing member 110a and a lower housing member 110b, and the upper housing member 110a and the lower housing members 110b are assembled to accommodate the optical transmission assembly 120. The optical module 100 in FIG. 1 may be understood as an optical transceiver, and the housing 110 may be understood as a transceiver housing.

According to an embodiment, the optical transmission assembly 120 may include a baseplate 121, an active optical component 122, an optical fiber connector 123, an optical fiber 124 and a sealing component 125. In the embodiment of the optical module 100, referring to FIG. 2, the optical fiber connector 123 of the optical transmission assembly 120 is a boot for active optical cable (AOC), but the disclosure is not limited thereto. In an embodiment, the optical fiber connector 123 may include a sleeve 123a and a holder 123b coupled to each other.

According to an embodiment, the baseplate 121 may be located in the housing 110. In an embodiment, the baseplate 121 may be a printed circuit board assembly (PCBA), and the contact pads at one end thereof may be served as an electrical interface of the optical module 100. In an embodiment, the baseplate 121 may be a metal board or a ceramic board coupled to the PCBA.

According to an embodiment, the active optical component 122 may be coupled to the baseplate 121. In an embodiment, the active optical component 122 may include one or more optical transmitting units and/or one or more optical receiving units, wherein each optical transmitting unit may include one or more laser diodes, and each optical receiving unit may include one or more photodiodes. In an embodiment, the laser diodes or photodiodes may be mounted on a laser submount. In an embodiment, each of the optical transmitting unit and the optical receiving unit may include a silicon photonics chip or a lithium niobate chip. In an embodiment, the active optical component 122 may further include a wiring line for transmitting a radio frequency signal to the optical transmitting unit. In an embodiment, each optical transmitting unit may be a transmitter optical subassembly (TOSA), and each optical receiving unit may be a receiver optical subassembly (ROSA).

According to an embodiment, the optical fiber connector 123 may be coupled to the housing 110. In an embodiment, the optical fiber connector 123 serves as an optical interface of the optical module 100. In an embodiment, in addition to the optical fiber connector 123, the optical transmission assembly 120 may further include an additional passive optical component, such as but not limit to an optical isolator, a fiber array, a wavelength division multiplexer, a demultiplexer and a focusing lens.

According to an embodiment, the optical fiber 124 may include a first end portion 124a and a second end portion 124b. In an embodiment, the optical fiber 124 may be a single fiber, multiple fibers, a fiber array, a ribbon fiber (jumper) or a bundle fiber at least partially located in the housing 110. In an embodiment, referring to FIG. 3, the optical fiber 124 may pass through the sleeve 123a.

According to an embodiment, the first end portion 124a may be optically coupled to the active optical component 122, and the second end portion 124b may be coupled to the optical fiber connector 123. In an embodiment, the first end portion 124a may include an end facet. The end facet may be directly optically coupled to the active optical component 122, or indirectly optically coupled to the active optical component 122 through one or more passive optical components (not shown). In an embodiment, the first end portion 124a is positioned closer to the active optical component 122 than the second end portion 124b. In an embodiment, the second end portion 124b is closer to the optical fiber connector 123 than the first end portion 124a.

In an embodiment, referring to FIG. 4, the second end portion 124b may be coupled to the optical fiber connector 123 via an adhesive AD. In an embodiment, the second end portion 124b of the optical fiber 124 may be coupled to the holder 123b via the adhesive AD.

In an embodiment, the second end portion 124b may be the optical fiber portion in contact with the adhesive AD or the optical fiber portion adhered to the holder 123b. In an embodiment, the second end portion 124b may be configured to transmit an optical signal to outside of the optical module 100 or transmit the optical signal to an optical cable coupled to the optical fiber connector 123.

According to an embodiment, the sealing component 125 may be located in the housing 110. According to an embodiment, the second end portion 124b of the optical fiber 124 may be sealed in the sealing component 125. In an embodiment, the second end portion 124b of the optical fiber 124 may be sealed in the sealing component 125 to a degree that does not allow the coolant to flow into the chamber formed in the sealing component 125. In an embodiment, the second end portion 124b may be sealed in the sealing component 125 hermetically or non-hermetically. In an embodiment, at least half of volume of the optical fiber 124 may be sealed in the sealing component 125. In an embodiment, the entirety of the optical fiber 124 may be sealed in the sealing component 125. In an embodiment, the sealing component 125 may be coupled to the holder 123b. In an embodiment, the entirety of the optical fiber 124 may include all portions of the optical fiber 124 located in the housing 110. Accordingly, it can be understood that one or more portions of the optical fiber 124, which are proximate to the adhesive AD, are sealed in the sealed sealing component 125.

In an embodiment, referring to FIG. 2, the sealing component 125 may extend along a longitudinal direction D1 of the optical module 100 from the optical fiber connector 123 to the baseplate 121. In an embodiment, the sealing component 125 may extend along the longitudinal direction D1 of the optical module 100 from a retaining ring of the sleeve 123a of the AOC to the baseplate 121.

In an embodiment, referring to FIG. 2, the sealing component 125 may include an upper cover 125a and a lower cover 125b assembled together. In an embodiment, both the upper cover 125a and the lower cover 125b may extend along the longitudinal direction D1 of the optical module 100 from the optical fiber connector 123 to the baseplate 121. In an embodiment, the upper cover 125a and the lower cover 125b cover the two opposite sides of the baseplate 121, respectively.

In an embodiment, referring to FIG. 2, the first end portion 124a of the optical fiber 124 and the active optical component 122 may both be sealed in the sealing component 125.

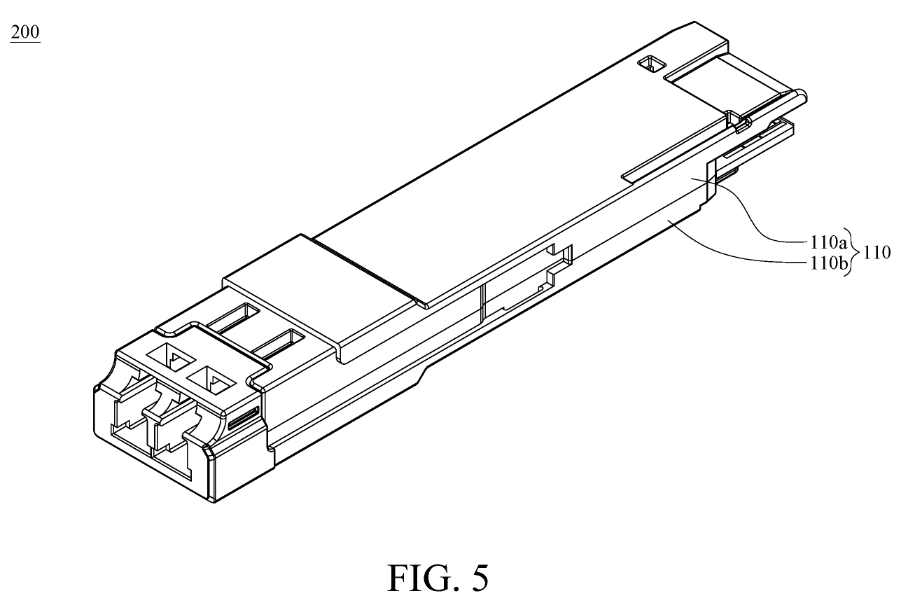

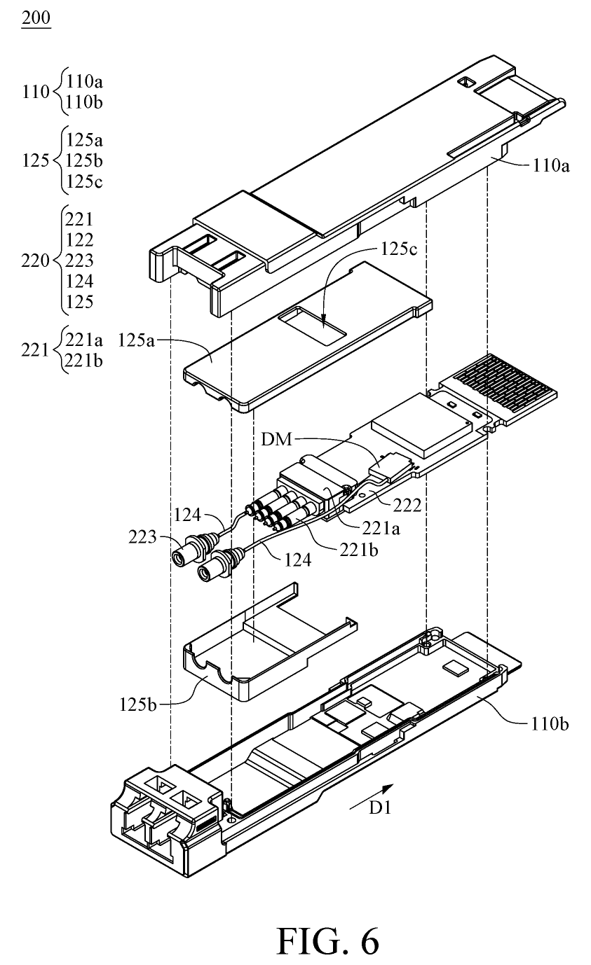

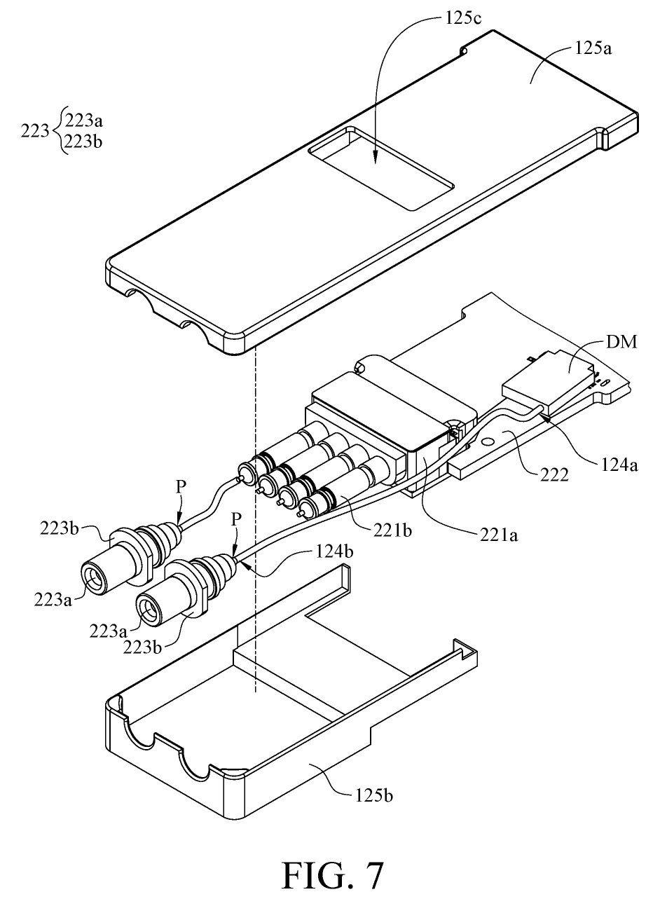

FIG. 5 is a perspective view of an optical module 200 according to another embodiment of the present disclosure; FIG. 6 is an exploded view of the optical module 200 of FIG. 5, and FIG. 7 is a partially enlarged view of an optical transmission assembly 220 of FIG. 6.

The optical module 200 and the optical module 100 have similar structures, and therefore, repetitive descriptions are omitted.

In the embodiment of the optical module 200, referring to FIGS. 5 and 6, the optical fiber connector 223 of the optical transmission assembly 220 is an LC connector. In an embodiment, referring to FIG. 7, the LC connector may include a receptacle body 223a and a flange 223b coupled to the receptacle body 223a. In an embodiment, the optical fiber coupling portion P of the receptacle body 223a may be located at a side of the flange 223b facing the baseplate 221. In an embodiment, the optical fiber coupling portion P may be coupled to the sealing component 125. In an embodiment, an adhesive may be applied at the optical fiber coupling portion P to ensure stable optical coupling between the optical fiber 124 and an external fiber connector received in the receptacle body 223a, and such adhesive is located in the sealing component 125.

In this embodiment, referring to FIG. 7, the baseplate 221 may include a box housing 221a and an optical fiber receptacle 221b coupled together. In an embodiment, at least a portion of the active optical component 122 may be located in the box housing 221a and supported on the inner surface of the box housing 221a. In an embodiment, the first end portion 124a of the optical fiber 124 optically coupled to the optical fiber receptacle 221b may be coupled to the optical fiber receptacle 221b and optically coupled to the active optical component 122 through the optical fiber receptacle 221b, and the first end portion 124a may be located in the sealing component 125. In an embodiment, the first end portion 124a may be directly coupled to a ferrule, and the ferrule is inserted into the optical fiber receptacle 221b to make the first end portion 124a indirectly coupled to the optical fiber receptacle 221b.

In an embodiment, a demultiplexer DM may be located outside the box housing 221a of the baseplate 221 and in the sealing component 125. In an embodiment, the optical transmitting unit (e.g., a laser diode) of the active optical component 122 may be located in the box housing 221a, and the optical receiving unit (e.g., a photodiode) of the active optical component 122 may be supported on the circuit board assembly 222 and optically coupled to the demultiplexer DM. In an embodiment, referring to FIG. 7, the first end portion 124a of another optical fiber 124 optically coupled with the demultiplexer DM may be located in the sealing component 125.

In an embodiment, the second end portion 124b may be an end of the optical fiber coupled to the LC connector.

In this embodiment, the sealing component 125 may extend along the longitudinal direction D1 of the optical module 200 from the optical fiber connector 223 to the baseplate 221. In an embodiment, the sealing component 125 may extend along the longitudinal direction D1 of the optical module 200 from the flange 223b of the LC optical connector to the baseplate 221.

In this embodiment, the sealing component 125 may have a window 125c exposing the box housing 221a. In an embodiment, the upper cover 125a of the sealing component 125 may have this window 125c. In an embodiment, the box housing 221a is bonded to the window 125c by, for example, filling a gap between the box housing 221a and the window 125c with transparent glue, and thereby preventing the coolant from flowing into the interior of the sealing component 125 through the gap. The formation of the window 125c provides a certain degree of assembly tolerance between the box housing 221a and the sealing component 125. Additionally, the window 125c allows a part of the box housing 221a to be located outside the sealing component 125, or even protrude beyond its outer surface, thereby enabling thermal contact between the box housing 221a and the housing 110.

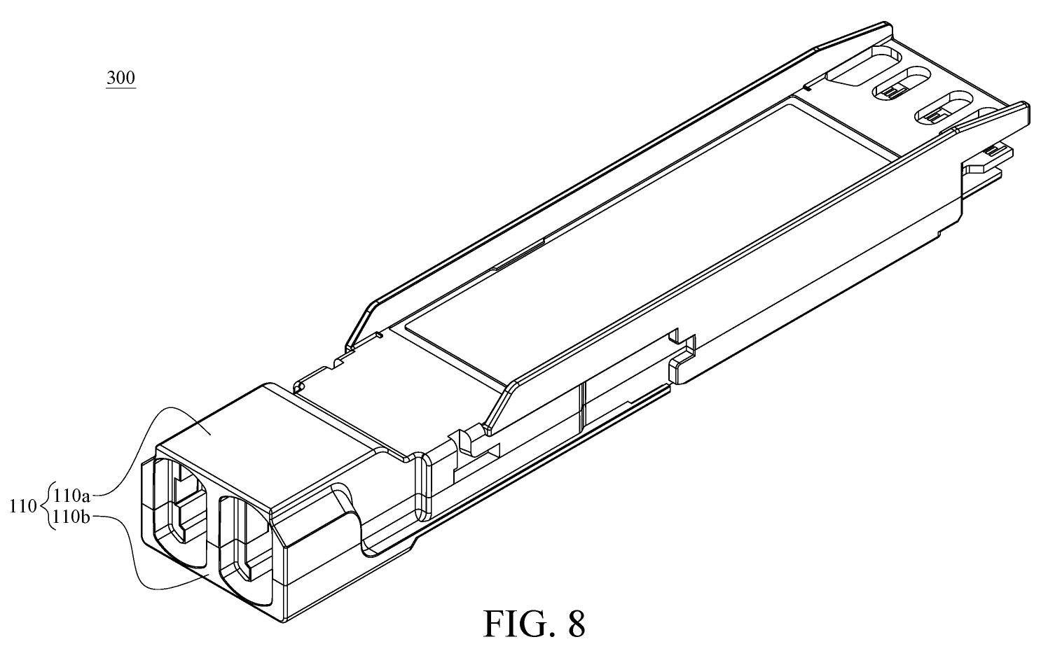

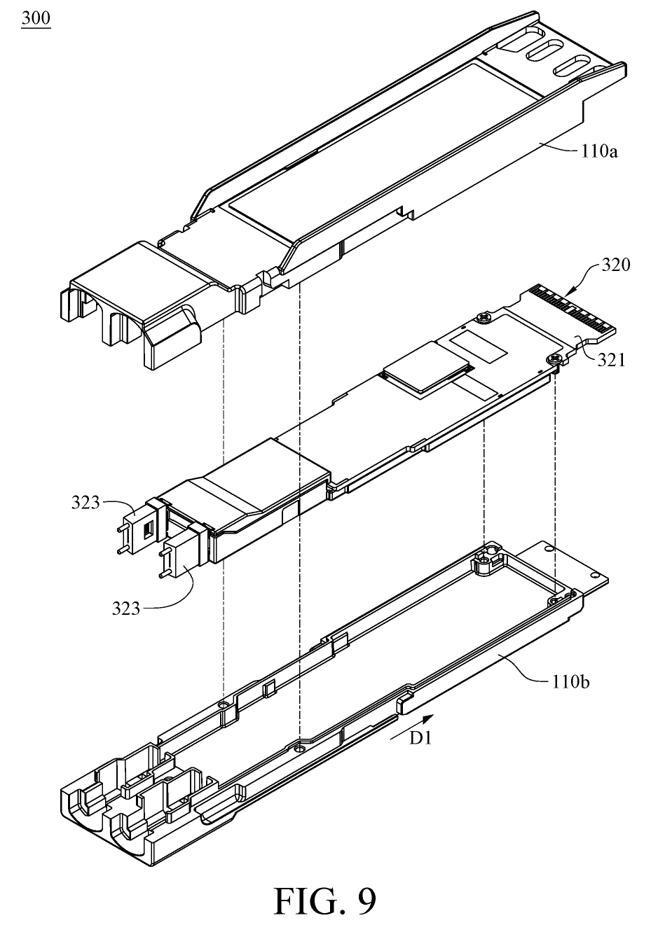

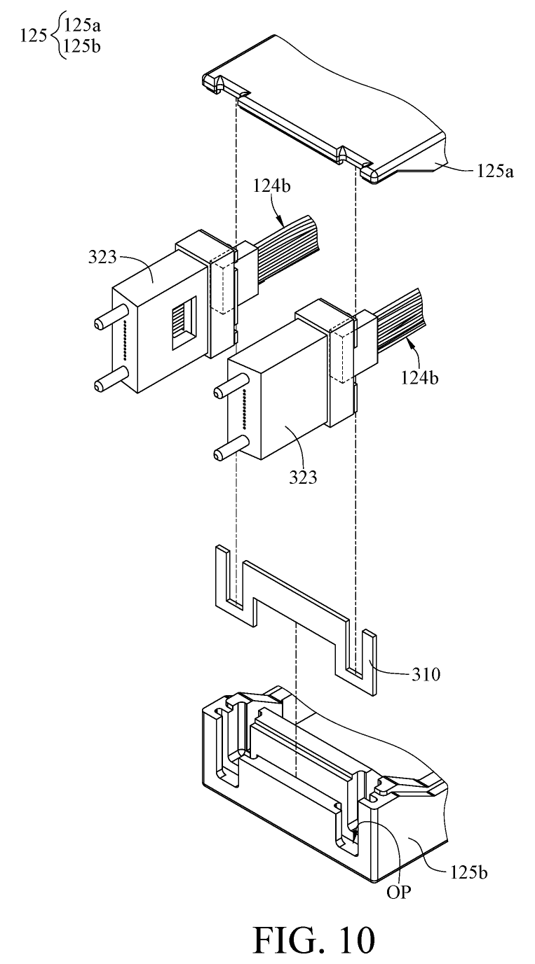

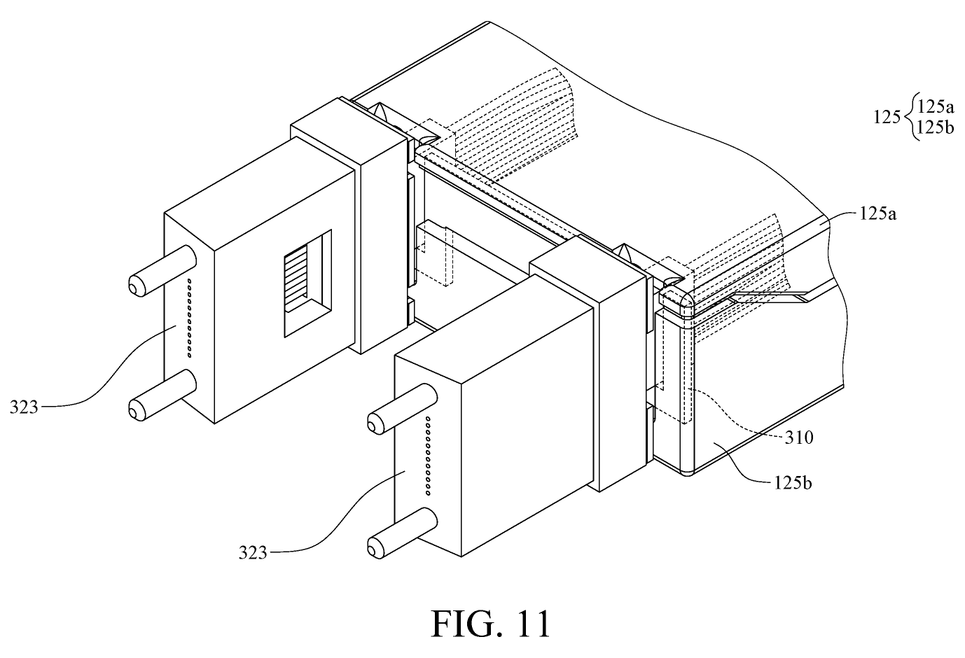

FIG. 8 is a perspective view of an optical module 300 according to yet another embodiment of the present disclosure. FIG. 9 is a exploded view of the optical module 300 of FIG. 8. FIG. 10 is a partially enlarged exploded view of an optical transmission assembly 320 of FIGS. 9, and 11 is a schematic diagram of the assembly of an MPO connector with a sealing component of FIG. 10.

The optical module 300 and the optical module 100 have similar structures, and therefore, repetitive descriptions are omitted.

In the embodiment of the optical module 300, referring to FIGS. 8 and 9, the optical fiber connector 323 of the optical transmission assembly 320 is an MPO connector. In this embodiment, the optical fiber connector 323 is an MPO male connector. In this embodiment, referring to FIG. 10, the optical module 300 may further include a sealing reinforcement member 310.

In this embodiment, the sealing component 125 may extend along the longitudinal direction D1 of the optical module 300 from the optical fiber connector 323 to the baseplate 321. In an embodiment, referring to FIG. 9, the sealing component 125 may extend along the longitudinal direction D1 of the optical module 300 from the MPO male connector to the baseplate 321.

In this embodiment, the MPO connector may pass through an opening OP of the sealing component 125 and be coupled to the sealing component 125. In an embodiment, referring to FIG. 10, the MPO connector may pass through an opening OP of the lower cover 125b of the sealing component 125 and be coupled to the edge of opening OP.

In this embodiment, the sealing reinforcement member 310 may cover a gap between the MPO connector and the opening OP, thereby improving the sealing degree, and avoiding the coolant to enter the interior of the optical module from the gap. In an embodiment, the sealing reinforcement member 310 is a metal plate.

In this embodiment, the second end portion 124b may be an end of the optical fiber coupled to the MPO male connector. In an embodiment, an adhesive may be applied at the joint between the optical fiber and the MPO male connector to ensure stable optical coupling between the optical fiber and an external fiber connector such as a MPO female connector, and the adhesive is located in the sealing component 125.

In an embodiment, the assembly view of components such as the sealing component 125, the sealing reinforcement member 310, and the optical fiber connector 323 may be illustrated as FIG. 11. Since the sealing reinforcement member 310 helps ensure sealing integrity, the optical fiber connector 323 does not need to be tightly fixed to the sealing component 125, allowing the optical fiber connector 323 to have a degree of freedom of movement, and thus the optical fiber connector 323 can effectively couple with an external connector.

In view of the above description, according to the optical module and optical transmission assembly disclosed in the embodiment of the present disclosure, with the sealing component of the present disclosure, the optical path can be protected from damage caused by a coolant when the optical module is immersed into the coolant. The sealing component may prevent the coolant from contacting the passive optical component and adhesive within the optical module.

In addition, by providing a sealing reinforcement member in the sealing component, an optical fiber connector may have a degree of freedom of movement, and letting the optical fiber connector effectively couple with an external connector. Furthermore, the sealing component of the present disclosure may be applied to an optical module with various connectors.

The embodiments are chosen and described in order to best explain the principles of the present disclosure and its practical applications, to thereby enable others skilled in the art to best utilize the present disclosure and various embodiments with various modifications as are suited to the particular use being contemplated. It is intended that the scope of the present disclosure is defined by the following claims and their equivalents.

What is claimed is:

1. An optical module, comprising:
a housing;
a baseplate located in the housing;
an active optical component coupled to the baseplate;
an optical fiber connector coupled to the housing;
an optical fiber comprising a first end portion optically coupled to the active optical component and a second end portion coupled to the optical fiber connector; and
a sealing component located in the housing, wherein the second end portion of the optical fiber is sealed in the sealing component.

2. The optical module according to claim 1, wherein the sealing component extends along a longitudinal direction of the optical module from the optical fiber connector to the baseplate, and the first end portion of the optical fiber and the active optical component are both sealed in the sealing component.

3. The optical module according to claim 1, wherein the sealing component comprises an upper cover and a lower cover assembled together, the upper cover and the lower cover both extending along a longitudinal direction of the optical module from the optical fiber connector to the baseplate, and the upper cover and the lower cover covering opposite sides of the baseplate, respectively.

4. The optical module according to claim 1, wherein at least half of volume of the optical fiber is sealed in the sealing component.

5. The optical module according to claim 4, wherein an entirety of the optical fiber is sealed in the sealing component.

6. The optical module according to claim 1, wherein the second end portion of the optical fiber is coupled to the optical fiber connector via an adhesive.

7. The optical module according to claim 1, wherein the optical fiber connector is a LC connector, the LC connector comprises a receptacle body and a flange coupled to the receptacle body, an optical fiber coupling portion of the receptacle body is located at a side of the flange facing the baseplate, and the optical fiber coupling portion is coupled to the sealing component.

8. The optical module according to claim 1, further comprising a sealing reinforcement member, wherein the optical fiber connector is an MPO connector, the MPO connector passes through an opening of the sealing component and is coupled to the sealing component, and the sealing reinforcement member covers a gap between the MPO connector and the opening.

9. The optical module according to claim 1, wherein the optical fiber connector comprises a sleeve and a holder coupled to each other, the optical fiber passes through the sleeve, the second end portion of the optical fiber is coupled to the holder via an adhesive, and the holder is coupled to the sealing component.

10. The optical module according to claim 1, wherein the baseplate comprises an optical fiber receptacle and a box housing sealed in the sealing component, the active optical component is located in the box housing and supported on an inner surface of the box housing, the first end portion of the optical fiber is coupled to the optical fiber receptacle and optically coupled to the active optical component through the optical fiber receptacle, and the sealing component has a window exposing the box housing.

11. An optical transmission assembly, comprising:
a baseplate;
an active optical component coupled to the baseplate;
an optical fiber connector;
an optical fiber comprising a first end portion optically coupled to the active optical component and a second end portion coupled to the optical fiber connector; and
a sealing component coupled to the optical fiber connector, wherein the second end portion of the optical fiber is sealed in the sealing component.

12. The optical transmission assembly according to claim 11, wherein at least half of volume of the optical fiber is sealed in the sealing component.

13. The optical transmission assembly according to claim 12, wherein an entirety of the optical fiber is sealed in the sealing component.

14. The optical transmission assembly according to claim 11, wherein the second end portion of the optical fiber is coupled to the optical fiber connector via an adhesive.

15. The optical transmission assembly according to claim 11, wherein the optical fiber connector is a LC connector, the LC connector comprises a receptacle body and a flange coupled to the receptacle body, an optical fiber coupling portion of the receptacle body is located at a side of the flange facing the baseplate, and the optical fiber coupling portion is coupled to the sealing component.

16. The optical transmission assembly according to claim 11, wherein the optical fiber connector is an MPO connector, and the MPO connector is coupled to the sealing component.

17. The optical transmission assembly according to claim 11, wherein the optical fiber connector comprises a sleeve and a holder coupled to each other, the optical fiber passes through the sleeve, the second end portion of the optical fiber is coupled to the holder via an adhesive, and the holder is coupled to the sealing component.

18. The optical transmission assembly according to claim 11, wherein the baseplate comprises an optical fiber receptacle and a box housing sealed in the sealing component, the active optical component is located in the box housing and supported on an inner surface of the box housing, the first end portion of the optical fiber is coupled to the optical fiber receptacle and optically coupled to the active optical component through the optical fiber receptacle, and the box housing has a window exposing the box housing.

19. An optical module, comprising:
a housing;
a baseplate located in the housing;
an active optical component coupled to the baseplate;
an optical fiber connector coupled to the housing;
an optical fiber optically coupled to the active optical component and coupled to the optical fiber connector via an adhesive; and
a sealing component located in the housing, wherein an entirety of the optical fiber is sealed in the sealing component.

20. The optical module according to claim 19, further comprising a sealing reinforcement member, wherein the optical fiber connector is an MPO connector, the MPO connector passes through an opening of the sealing component and is coupled to the sealing component, and the sealing reinforcement member covers a gap between the MPO connector and the opening.
